(19) United States
(12) Patent Application Publication
(10) Pub. No.: US 2007/0136403 A1
(43) Pub. Date: Jun. 14, 2007

(54) System and method for thread creation and memory management in an object-oriented programming environment

(76) Inventor: Atsushi Kasuya, Los Altos Hills, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/301,482

(22) Filed: Dec. 12, 2005

(51) Int. Cl. G06F 17/30

(52) U.S. Cl. 707/206

(57) ABSTRACT

A system and method for thread management, including one or more smart pointers that can be identified while creating a copy of the stack, and incremented the reference counter within the smart pointer to reflect the copy operation.

### BACKGROUND OF THE INVENTION

1. Field of the Invention

This invention relates to memory management in a multi-thread programming environment. The target programming system is SystemC which is based on C++ programming language system.

2. Background

The C++ programming language does not contain a garbage collection mechanism. Instead, a pseudo-pointer under a user program, which is called ‘smart pointer’ and is commonly used in C++ environment as a template library, is provided as the extended programming environment.

Meanwhile, a set of libraries to support the hardware modeling with C++ is standardized as SystemC. SystemC provides the mechanisms to model the connection structure and the concurrent activity of a hardware system. Usually, a hardware system can be represented with a static concurrency, so that the concurrent thread of execution is declared at the beginning of the execution (simulation), and those threads communicate via static connections that represent the hardware structure.

Besides such modeling activities, the mechanism to construct the testing environment (called a testbench) is another important aspect of the hardware design. The testbench requires mechanisms to produce test patterns applied to the device under test (DUT), and check the correctness of DUT's behavior to the given pattern. Several dedicated hardware verification, languages (HVLs), such as Jeda and Vera were developed for such a purpose. In such hardware verification systems, dynamic concurrency that allows a new thread created along with program execution is commonly used to ease the construction of the testbench mechanism. In such a testbench system, it is important to construct a testing program in a simple, comprehensive manner at higher abstraction level of the system, and the dynamic concurrency helps construct the abstract model in such a way. The constraint of hardware. modeling (mainly required to eventually convert the model to an actual gate model as the final hardware device) is not necessary in such a testbench system. Another important feature in such hardware verification languages is the automatic memory management system known as garbage collection, which automatically collects unused segment of the memory pool for reuse.

With garbage collection support, a programmer can freely create a new object structure without having to plan for deallocation of sufficient memory space. Under complicated multi-threaded programming environment, managing the memory allocation/deallocation at the user's code level is very difficult, and slows down the development of the required testbench code. As HVL provides the garbage collection mechanism at the language level, and the programmer is freed from such a burden, the development of the code is much faster than the system without the garbage collection. Thus, in such a HVL system, the programming style of using dynamic thread creation and relying on existing garbage collection routines has been proven useful in developing the testbench quickly and cleanly.

Within SystemC development activities, providing features for testbench creation has been established, and introduced as an SCV library. SCV has various aspects of conventional testbench features, but adds a smart pointer-based garbage collection mechanism. In the core development of SystemC, it adds a dynamic thread creation mechanism that the user can start a new thread at the function entry.

But, because C++ system is originally designed for a single thread programming environment, and the multi-threading mechanism is just added later as a library, it cannot be used as cleanly as a dedicated HVL language. Especially, the issue of using smart-pointer-based garbage collection along with the dynamic thread creation mechanism is an annoyance. Within the HDL programming style for testbench creation that has been established with HVLs, it is common to create many dynamic threads and pass a various objects (data structure) to control the simulation. But even using SystemC with a SCV library (including smart pointers), the garbage collection mechanism often does not follow the user's expectation, and can cause serious programming problems.

Various hardware verification languages, such as Jeda, Vera, provide garbage collection mechanism and dynamic threading mechanism. These language use proprietary language syntax, and can not be directly linked with other common programming language such as C++.

Therefore, there is a need for an HVL having a garbage collection mechanism and dynamic threading that can be directly linked with other common programming languages such as C++.

### SUMMARY

As described herein, preferred embodiments of the invention include at leastthe following mechanisms:

1) a method to create a new thread of execution by moving the stack pointer with specific distance from the current stack pointer of non-thread execution.

2) a method to create a copy of a thread by copying the stack frame of current thread and store all the necessary register values into a memory area.

3) a method to execute the thread by copying the saved stack frame image back to the exact location in the stack space, and recover all the registers.

4) a method to create a copy of thread by creating the same execution image from a program execution point where the thread generation function is called, and identifying if the thread is a newly created one from the return value of the thread generation function.

5) a method to create a smart pointer object that can be identified while creating a copy of the stack, and incrementing the reference counter within the smart pointer to reflect the copy operation.

### BRIEF DESCRIPTION OF THE DRAWINGS

FIG. 1 shows an example memory space.

FIG. 2(a) shows a frame pointer register (FP) and a stack pointer register (SP) accessing a stack space allocates a structure that contains the pointer to the object, as well as the reference counter.

FIG. 2(b) shows multiple images of the stack stored in a heap memory.

FIG. 3 shows an example of memory in accordance with a preferred embodiment of the invention.

FIG. 4 is a flowchart of new thread generation.

FIG. 5 is a flowchart of context switching between threads is done by the flowchart of FIG. 4.

FIG. 6 is a flowchart of execution of a copy_thread function 602.

FIG. 7 is a diagram showing a chain of smart pointers.

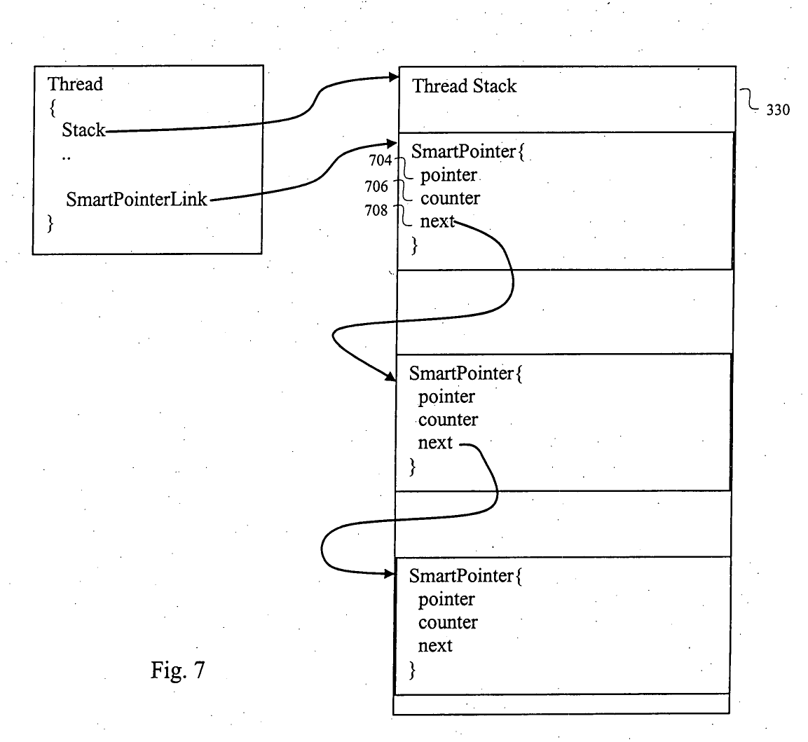

FIG. 8 is a flowchart showing adjustment of smart pointers.

The figures depict an embodiment of the present invention for purposes of illustration only. One skilled in the art will readily recognize from the following description that alternative embodiments of the structures and methods illustrated herein may be employed without departing from the principles of the invention described herein.

### DESCRIPTION OF PREFERRED EMBODIMENTS

The described embodiments of the invention allow a user to write a dynamic thread program with a Unix process-fork style programming interface. Also, the smart pointer in the described embodiments takes care of the proper garbage collection operation over the threading, and allows the user to pass objects among threads. The described embodiments implement a user-space thread. The mechanism used in a preferred embodiment to create the multi-threading stack is described below.

The examples in this document show a preferred thread generation mechanism in a generic CPU architecture having a stack pointer (SP), a function frame pointer (FP), and a continuous stack space. Various CPU architectures have various sets of registers, but most of those use this or a similar scheme for processing the execution of a program, and this generic mechanism can be easily mapped to any particular CPU architectures.

Usage of Addressing Space for Program Execution

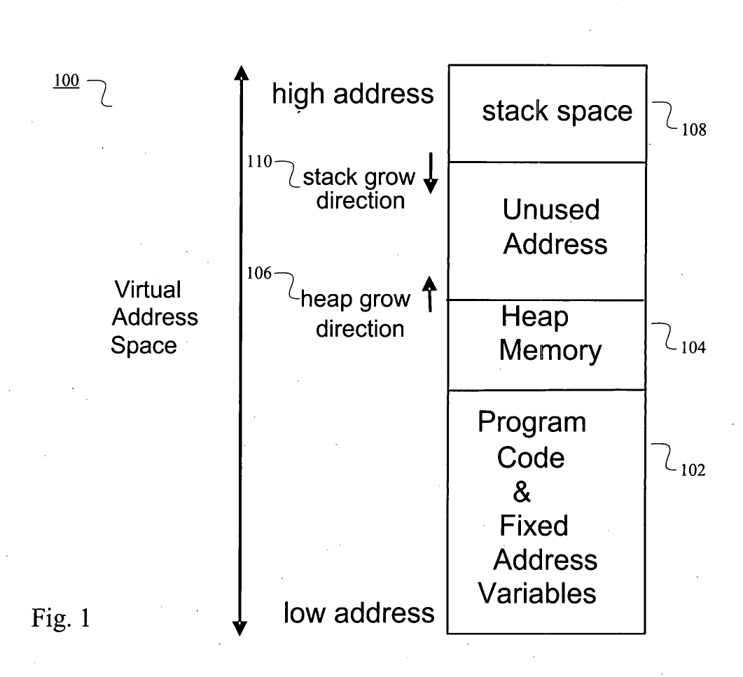

FIG. 1 shows an example memory space 100. The execution of a user program managed by typical operating systems is done with three-types of memory spaces. Program code and fixed address variables (global variables, static variables) 102 are located at the bottom of the address space 100. A heap memory space 104 is located next to the code and fixed address variables 102. The heap memory space 104 is used to allocate memory dynamically along with the program requests such as malloc( ), free( ) system calls. The heap 104 can grow 106 toward higher address. The stack space 108 is allocated at the top of the addressing space, and grows 110 toward the bottom. Thus, if there is. only one execution thread, the stack space 108 can grow until it hits the upper bound of the heap space 104.

Function Call Mechanism

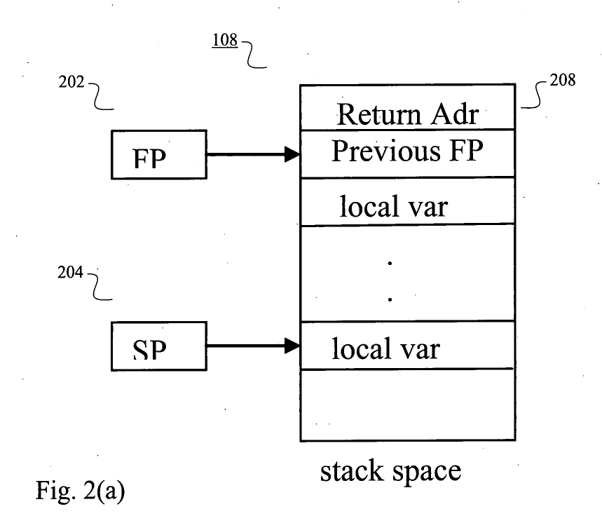

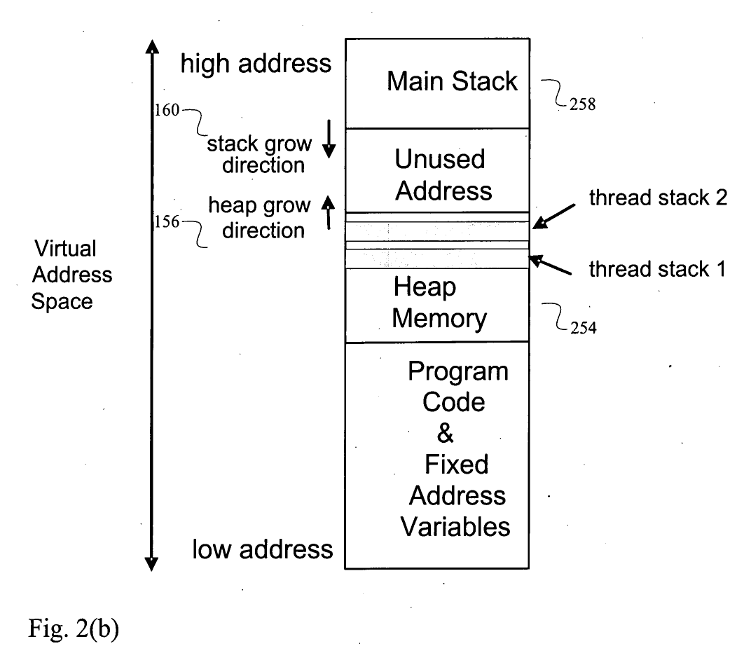

FIG. 2(a) shows a frame pointer register (FP) 202 and a stack pointer register (SP) 204 accessing stack space 108. When a function is called, a CPU (and corresponding compiler) uses one register 202 as a frame pointer (FP) to identify the local variable boundary for the function call. The stack pointer (SP) register 204 points to the end of stack, and the local variables are located between FP and SP. The return address 208 of the function is placed before the FP, and the previous FP value is saved in the stack where the FP register is pointing to. In FIG. 2(a), stack 108 is growing from top to bottom, and SP 204 points to the last valid entry on the stack space. FP 202 points to the start point of the local variable, and the previous FP value is saved at the stack pointed by FP itself.

In an execution model of the software (which is common to most CPU architectures), returning from a function is done as:
SP=FP;//copy FP to SP
FP=Stack[SP--];//pop operation from the stack, recover the previous FP value
PC=Stack[SP--];//pop return address to Program Counter
   Problem of Existing Thread Implementation

FIG. 2(b) shows multiple images of a stack 258 stored in a heap memory 254. In order to implement multiple threads, multiple images of the stack space must be created. A common mechanism of implementing multiple images of the stack space is to have such a space in heap memory 254. In this mechanism, a piece of memory is allocated from the heap space 254 as a thread stack. Initially, a program is executed with the main stack space as explained, but once a thread is created and the execution is transferred, the stack space is actually located in the heap. In such a case, the stack space must have a fixed size, and cannot be extended when it reaches to the end.

Another limitation of existing thread mechanisms is that a new thread can only be started at the beginning of a function. A simple example is:

void foo( ) {

//thread function beginning

}
void main( ) {
// creating a thread
create_thread( foo, .. ) ; // give a function entry

// as the beginning of thread

In the code above, the function ‘foo( )’ is executed as a new thread. The function address is given to the thread create function ‘create_thread’.

This programming interface is not common in programming languages that support dynamic concurrency (e.g., Jeda, Vera, SystemVerilog). In those languages, a copy of an execution image within a function can be created.

For example, a thread can be created with ‘fork’ ‘join’ pair in Jeda as:

void main( ) {

// creating a thread
fork
{
// body of thread 1 code
}
join_none

The statements within fork-join pair are executed concurrently as threads. In the code above, the code block encapsulated with { } pair is executed as a thread. It uses ‘join_none’ at the end, which means that the main code is executed without waiting the completion of the thread code. If ‘join’ is used instead, the main execution will wait for the completion of the child threads.

Another common concurrent programming interface is the ‘fork’ system call in the Unix operating system. With the fork( ) system call, the operating system creates an identical execution image, and returns the new process ID to the parent, and zero to the child. The following code shows an example. The major difference in this is that this ‘fork( )’ system call generated a copy of a process, not a thread. This means that the copy of entire virtual space will be created, and run as different programs in the system. Therefore, this technique cannot be used directly for this thread programming.

if( fork( ) == 0 ) {

// child process

}
else {

// parent process
}

The advantage of this style of thread generation is that it can share local variables. Thus, various parameters can be transferred through the local variables. When the function call style thread creation is used, passing an argument to the function is not simple. Current SystemC standard uses the mechanism called ‘bind’ , that creates an object image of a function call that contains the function address as well as arguments. (Detailed information about bind is found in ‘www.boost.org/libs/bind/bind.html’ which is herein incorporated by reference.) The problem of using such a mechanism is that the created image may possibly reference the local variable in the code that creates the thread. But when the thread is started, the parent code may not be active (exits from the function call), and the corresponding local variable may not be valid. Thus, SystemC standard suggests to only pass constant argument to the thread. This is a very inflexible, almost useless mechanism for thread generation.

Problem with Using a Smart Pointer

The C++ compiler does not provide a garbage collection mechanism, and the smart pointer template is provided to remedy this lack. This template relies on the C++ compiler to call the destructor code when the structure is removed. The destructor code manages the reference counter to keep truck of the object reference. Thus, when a smart pointer is allocated, it actually allocates a structure that contains the pointer to the object, as well as the reference counter. (A detailed explanation of the smart pointer mechanism can be found in U.S. Pat. No. 6,144,965, which is herein incorporated by reference.)

This smart pointer mechanism does not work in all situations for the same reason that the local variable cannot be passed as an argument of the thread. When it is referenced as an argument at ‘bind,’ there is no mechanism provided by the compiler to adjust the reference counter. Thus, when the parent code exits, the destructor is called and the pointed object will be destructed before being referenced by the thread.

An Embodiment Thread Generation Mechanism of this Invention

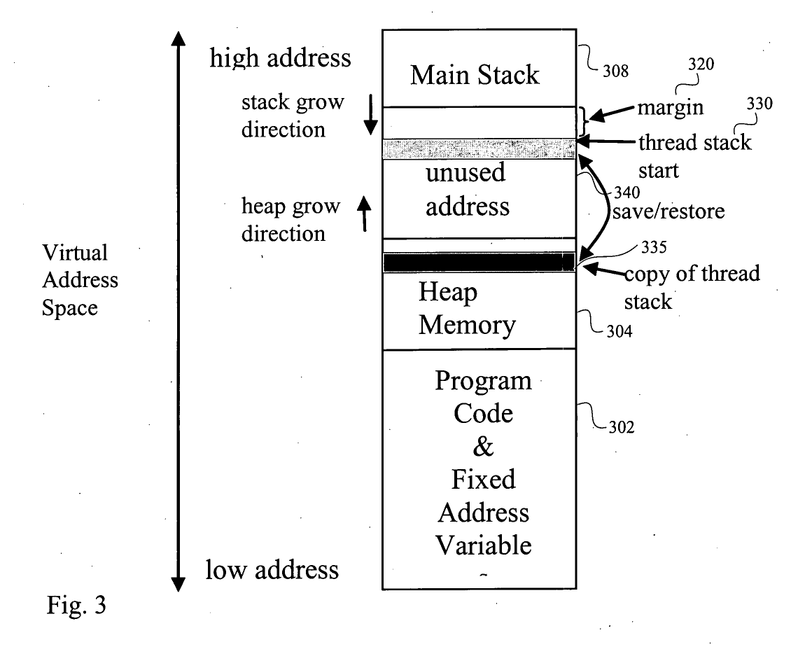

FIG. 3 shows an example of memory in accordance with a preferred embodiment of the invention. The thread stack 308 in preferred embodiments of the present invention uses an extended space of the main stack space. When a first thread is created from non-threaded program code, a constant offset (also called a margin) 320 is added to the current stack pointer. In such a case, a thread stack start point 330 is given as the beginning of a function. So far, this is the same as the standard SystemC thread generation. By adding the offset 320, the thread generation can be done from various points of non-threaded program code, because the depth of the current stack for the various points will be different. This stack depth depends on the depth of function calls and the number of local variables. By adding a big enough offset 320 as the margin, those depth difference can be absorbed in most cases. An example of such an offset is 2K bytes (2048 bytes). Another example is 1K bytes (1024 bytes).

The second and subsequent times a thread is generated, the stack area of a new thread always starts from the same point 330. When a current thread is suspended and execution switches to another thread, the stack area is saved into a block of memory 335 allocated in the heap area 304. The necessary register values such as stack pointer and frame pointer (not shown) are also saved. When the thread is resumed, the resumed thread's stack will be restored into the extended stack space beginning at point 340 and the register values are restored as well.

With this mechanism, the thread stack is allocated in the extended area of the main stack, and regular virtual address allocation scheme for regular stack frames can be used as is. The stack space for a thread can be extended up to the heap memory boundary as is usual for a non-thread program.

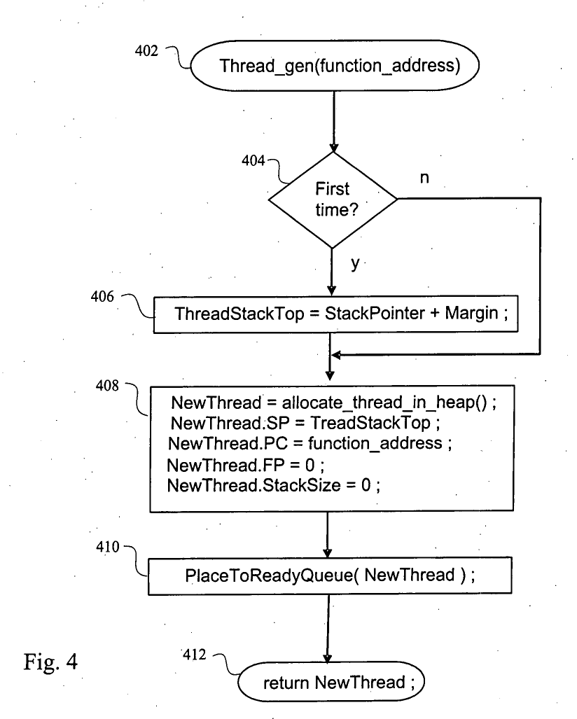

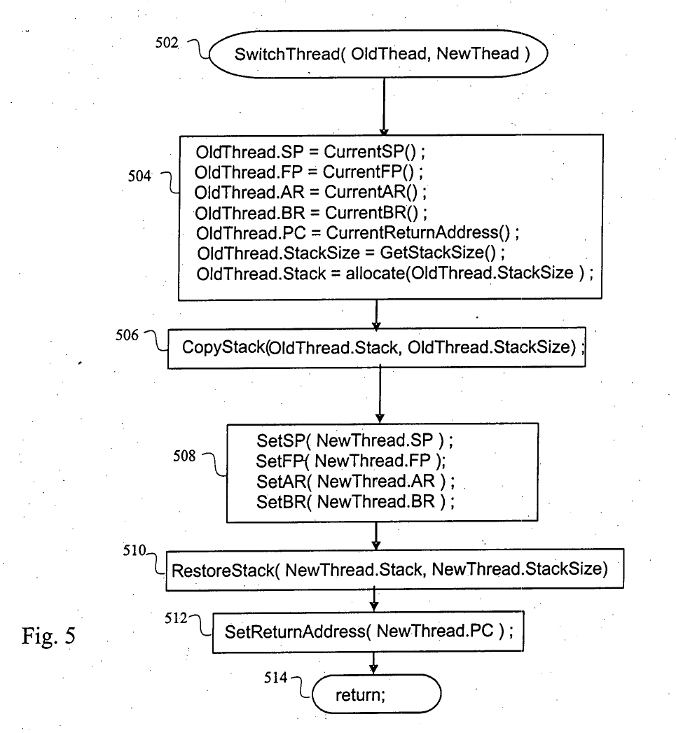

The flowchart of FIG. 4 shows the mechanism 402 of new thread generation. In the flowchart, during the first execution 404, a variable ‘ThreadStackTop’ is used to keep the start address 330 of the thread stack 406. As shown in element 408, the thread structure ‘NewThead’ is allocated in the heap 304, and holds the necessary information to execute the thread. In the thread structure ‘NewThread,’ ‘SP’ holds the stack pointer which is set to the top, ‘PC’ holds the address of execution which is set to the function_addr passed as an argument of the function, ‘FP’ holds the frame pointer register value which is set to zero, and ‘StackSize’ holds the size of stack space which is set to zero as the initial state. Next, the new thread is placed in a ready queue of threads that are ready to execute 410 and the new thread is returned 412. With the thread structure, the context switching 502 between threads is done by the flowchart of FIG. 5. The elements of FIG. 5 are called from the thread scheduler to switch the thread context.

In element 504 of the flowchart, the register values and return address which are read from the stack frame are saved to an OldThread structure in the heap 304. Here we assume there are two general purpose registers AR and BR in which the original values are kept. So, the values of those registers are saved to the OldThread structure. The function GetStackSize( ) returns the size of necessary memory to save the stack frame of the current thread. The proper block of memory is allocated to ‘Stack’ in the structure.

In element 506, the copy of the thread's stack is copied to the allocated area in the heap.

In element 508, various register values from the NewThread structure in the heap are restored.

In element 510, the Stack (saved stack frame) is restored to the stack memory space used for threads. In element 512, the PC value is stored into the corresponding return address area in the stack frame, so that returning from this finction will transfer control to the new thread.

The Thread Copy Generation Mechanism

In accordance with the stack mechanism explained above, embodiments of the invention allow creation of a copy of the thread execution image, instead of the beginning of a function to start a thread.

The programming interface to generate a copy of thread can be similar to the process generation system call in Unix system. For example:

void foo( ) {

// creating a copy of thread
if( copy_thread( ) == 0 )
{
// code for child thread
}
else {

// code for parent thread

}

}

When copy_thread is called, it creates a copy of the current execution image, and returns the new thread ID to its parent, and 0 (zero) to the newly created thread. Thus, by testing the return value of the thread generation function, the program knows if it is a parent or a child.

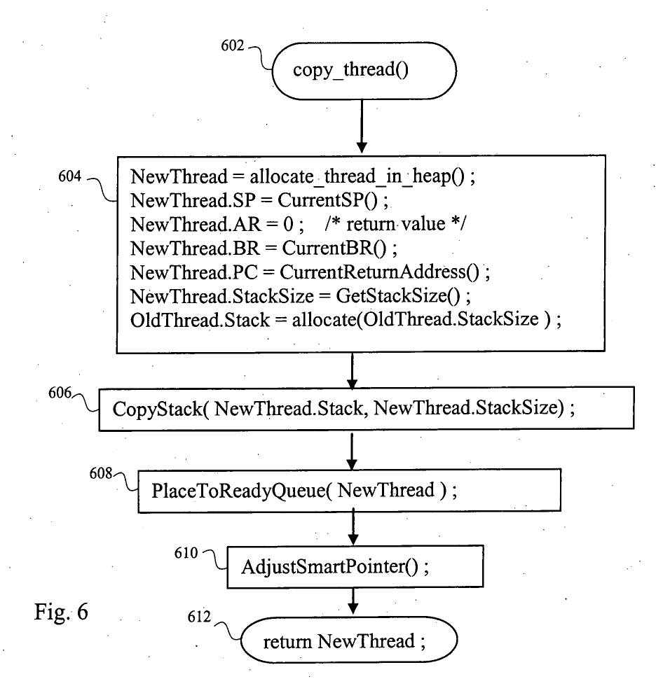

FIG. 6 shows a flowchart for creating a copy of a thread. In element 604, the thread copy generation finction ‘copy_thread( )’ 602 allocates a new copy area in the heap 304, and generates a copy of the current thread by copying the stack frame and necessary register values. The copy function sets 0 (zero) as the return value AR (usually done by one of the registers) to the generated copy. The thread stack is also copied to Stack, and this structure is registered 608 to be ready in the thread scheduler. This new thread is placed in the ready queue 608 for the thread scheduler so that it will be executed in turn. Then control returns to the parent (caller of copy_thread( )) with the new thread ID (this could be a pointer to the thread info). When the new thread is executed, the exact copy of stack image is restored to the same address space in the extended stack area, and it receives 0 (zero) as the return value from the thread generation function.

In order to implement thread copying, it is necessary to allocate the stack space to the same address range as the original. This is because most CPU architectures define temporal registers to keep any value for optimization. These registers are not destructed for function calls (values are saved and restored by the callee function). Thus, some registers can hold a pointer to a stack space. Most of the time, it is not possible to know if such a register holds a pointer to a local variable as it is depends on the compiler, the optimization level, etc. Thus, to maintain the same execution image, we have to save such register values as is, and maintain the addressing space for the stack. Such a mechanism cannot be provided if the stack area for a thread is allocated in the heap area.

Smart Pointer

The element in the flowchart of FIG. 6 calls a function AdjustSmartPointer( ) 610. This will be explained below. Element 612 returns the address of the thread structure, to tell the caller that the execution is for parent thread.

When the newly created thread is executed, its AR register is initially zero, and that represent the return value from the copy_thread function, telling the caller that the execution is for child thread.

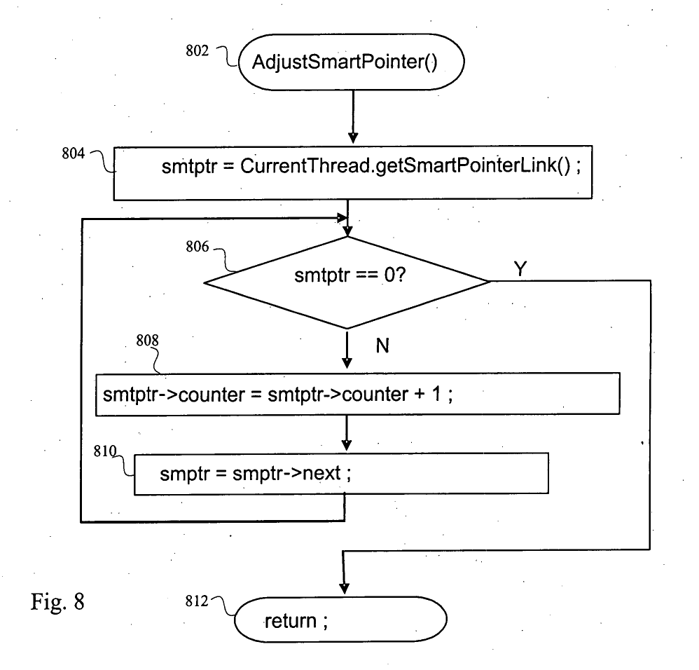

The new smart pointer mechanism as described for embodiments of this invention uses a mechanism to identify all the smart pointers that allocated in the stack space. There are various ways to implement such a mechanism. Here, we show an example that the smart pointer has a linked list, and all the smart pointers created under a thread are linked to a thread structure. FIG. 8 shows an example of this implementation.

Besides the pointer itself 704 and the reference counter 706 as ordinal smart pointer structure, a smart pointer has a link pointer ‘next’ 708 and all the smart pointer allocated in the local stack of a thread is connected to a link started from the thread structure.

Because the C++ language has a constructor function that is always called when it is allocated, this link can be connected within the constructor. In order to determine whether allocation is in the heap area, we can examine the address of the object (it is given as ‘this’ in C++), and compare it with the stack space. Or we can limit the usage of this type of smart pointer to the local variables only. (Later implementations will be executed faster without the checking.) When a copy of a thread is created, AdjustSmartPointer( ) function is called as shown in element 610 of the previous flowchart. In the AdjustSmartPointer( ) function 802, the reference counters of all the smart pointers in the chain will be incremented by one to reflect that a copy of the pointer has been created. The flow chart of FIG. 8 shows the example implementation of the adjustment. It reads the top pointer from the current thread structure 804, and increment the counter until the next pointer is zero 806-810. This mechanism allows all the local variables within a thread to be shared with the spawned child thread safely, and solves the difficulty of passing parameter to a child thread in the original SystemC thread spawn mechanism.

While the present invention has been described with reference to certain preferred embodiments, those skilled in the art will recognize that various modifications may be provided. Variations upon and modifications to the preferred embodiments are provided for by the present invention, which is limited only by the following claims.

We claim:

1. A method of managing software threads in a data processing system having a memory, comprising:
establishing a main stack in the memory;
establishing a thread stack in the memory at a location past the current end of the main stack plus a predetermined margin value;
establishing a heap in the memory at a predetermined location in the memory; and
switching to a new executable thread by storing a current executable thread in the heap and switching the new executable thread from the heap to the thread stack.

2. A method of managing software threads in a data processing system having a memory, comprising:
establishing a main stack in the memory;
establishing a thread stack in the memory at a location past the current end of the main stack plus a predetermined margin value;
establishing a heap in the memory at a predetermined location in the memory; and
copying a current thread in the thread stack by:
allocating a new thread in the heap, copying information from the current thread to the new thread, and adjusting a smart pointer for a shared local variable to indicate that there is more than one thread using the shared local variable.

3. The method of claim 1, further including placing the new executable thread in a ready queue to be executed.

4. The method of claim 2, further including placing the copied thread in a ready queue to be executed.

5. The method of claim 1, wherein the stack and heap grow in opposite directions.

6. The method of claim 2, wherein the stack and heap grow in opposite directions.

7. The method of claim 1, wherein new threads are generated in the heap and transferred to the stack when they are executed.

8. The method of claim 2, wherein new threads are generated in the heap and transferred to the stack when they are executed.

9. The method of claim 2, wherein the smart pointer is part of a chain of smart pointers representing all local variables referenced by a thread.

10. A system containing executable software threads, comprising:
a main stack in a memory;
a thread stack in the memory at a location past the current end of the main stack plus a predetermined margin value;
a heap in the memory at a predetermined location in the memory;
a chain of smart pointers in the heap, representing local variables used by threads, each smart pointer containing a reference count of a number of threads in which the local variable is referenced, the reference count of all smart pointers in the chain being adjusted each time the thread referencing the local variables is copied.

11. The system of claim 10, wherein the chain of smart pointers represents all local variables referenced by a thread.
